(19) United States
(12) Patent Application Publication
(10) Pub. No.: US 2003/0038131 A1
(43) Pub. Date: Feb. 27, 2003

(54) Vacuum cooking method using a microwave oven and a vacuum-sealed container used for the method

(75) Inventors: Minoru Nomura, Nagoya-shi (JP); Hitoshi Nomura, Nagoya-shi (JP)

Correspondence Address: MORGAN LEWIS & BOCKIUS LLP, 1111 PENNSYLVANIA AVENUE NW, WASHINGTON, DC, 20004, US

(73) Assignee: HIKARI KINZOKU INDUSTRY CO., LTD.

(21) Appl. No.: 10/218,161

(22) Filed: Aug. 14, 2002

(30) Foreign Application Priority Data
Aug. 21, 2001 (JP) JP2001-250204
Jul. 12, 2002 (JP) JP2002-204416

(51) Int. Cl. H05B 6/80

(52) U.S. Cl. 219/735; 219/686

(57) ABSTRACT

A vacuum sealed container and a method for cooking food under vacuum including the steps of heating the food and the cooking liquid in a heat-and-cold resistant vacuum-sealed container having microwave permeability using the microwave oven at high power for boiling, heating the container for a required time, stopping the heating to cool the container, thereby producing a vacuum therein, heating the container for a required time to cook the food and the cooking liquid at low temperatures using the microwave oven at low power, while the container is under vacuum, and allowing the container to cool.

### BACKGROUND OF THE INVENTION

1. Field of the Invention

The present invention relates to a vacuum cooking method using a microwave oven and a vacuum-sealed container used for the method.

2. Description of Related Art

Simmered dishes cooked by a microwave oven are generally heated at high power in a lidded pot made of heat-resistant glass such as a Pyrex (a registered trademark of Corning Inc.). When simmering is required for permeation of a cooking liquid into food, either of the following two methods is pursued to heat the food: (1)cooking food for long hours by both microwave-oven heating and oven heating, and (2)cooking food for long hours in two steps of high-power heating and low-power heating using a microwave oven (Atsuko HIGO ed., A HANDBOOK FOR FOOD COOKED USING A MICROWAVE OVEN/MICROWAVES published by The Japan Industrial Journal-A Fujisankei Communications Group Company, pp. 65 to 66, and pp. 216 to 217).

A vacuum-cooking method has been known through which food is vacuum-packed, put in a hot water, and cooked at low temperatures for many hours (Takayuki TANI, ALL TECHNIQUES FOR VACUUM COOKING, published by Shibata Publishing Co. Ltd., pp. 8 to 9). In addition, a keep-warm cooking method has been known through which food in a regular lidded stainless-steel pot is heated and cooked by gas, and then it is put in a keep-warm box for cooking the food by remaining heat for long hours, where by a cooking liquid permeates the food, and its good taste is retained.

In the case of making simmered dishes using a microwave oven, in particular, which requires permeation of a cooking liquid thereinto, when Method (1) stated above is followed, food is cooked by microwave-oven heating, and then it is further cooked by oven heating. However, it is a time-consuming task as in the case of conduction heating by which food is heated by gas from outside. Also, in the case of Method (2) stated above, food is heated at high power for a short time and heated at low power for a long time. When a root crop is cooked using a microwave oven, for example, the crop is boiled in water first. Then, seasoning is added to it, and the crop is further heated using a microwave oven, so that a cooking liquid may be permeated thereinto, and cooking time may be accelerated. For cooking meat, under either Method (1) or Method (2), tasty juices from the meat are taken away due to long-time microwave-oven heating. Consequently, the meat may become tough, and cooked food may not be expected to be tasty.

On the other hand, cooking vacuum-packed meat can provide tasty food, but it is a time-consuming task because of low-temperature processing in hot water. Also, the meat may be undercooked because of conduction heating from outside. Further, air might remain among vacuum-packed meat ingredients, whereby the meat may be undercooked. As a result, hygienic problems may arise. It is harmful to eat undercooked food when harmful bacteria remain therein. Especially, pork may contain parasites, such as trichinella, harmful to a human body. Moreover, the keep-warming cooking is a time-consuming task.

### SUMMARY OF THE INVENTION

The present invention has been made in view of the above circumstances and has an object to overcome the above problems and to provide a cooking method for achieving an excellent result of cooking by microwave-oven heating and to provide a vacuum-sealed container for cooking food under the method.

To achieve the objects and in accordance with the purpose of the present invention, as embodied and broadly described herein, in the first aspect of the present invention, a vacuum cooking method for cooking food using a microwave oven, so that permeation of a cooking liquid into the food is accelerated, comprises the steps of heating the food and the cooking liquid in a heat-and-cold resistant vacuum-sealed container having microwave permeability using the microwave oven at high power for boiling, heating the container for a required time, stopping the heating to cool the container, thereby producing a vacuum therein, heating the container for a required time to cook the food and the cooking liquid at low temperatures using the microwave oven at low power, while the container is under vacuum, and allowing the container to cool.

In the second aspect of the present invention, a vacuum cooking method for cooking food using a microwave oven, so that a cooking liquid permeates into the food, and a good taste is condensed, comprises the steps of heating the food and the cooking liquid in a heat-and-cold resistant vacuum-sealed container having microwave permeability using the microwave oven at high power for boiling, heating the container for a required time, stopping the heating to cool the container, thereby producing a vacuum therein, heating the container for a required time to cook the food and the cooking liquid at low temperatures using the microwave oven at low power, while the container is under vacuum, allowing the container to cool, and storing the container in a refrigerator.

Yet, in the third aspect of the present invention, a vacuum cooking method for cooking food using a microwave oven, so that a cooking liquid permeates the food, and a good taste is condensed, comprises the steps of heating the food and the cooking liquid in a heat-and-cold resisting vacuum-sealed container having microwave permeability using the microwave oven at high power for boiling, heating the container for a required time, stopping the heating to cool the container to a predetermined temperature, thereby producing a vacuum therein, and placing the container in a keep-warm box for keep-warm cooking for a required time while the container is under vacuum.

Yet, in fourth aspect of the present invention, a vacuum cooking method for cooking food by microwave-oven heating and oven heating, so that a cooking liquid permeates the food, and a good taste is condensed, comprises the steps of heating the food and the cooking liquid in a heat-and-cold resistant vacuum-sealed container having microwave permeability using the microwave oven at high power for boiling, heating the container for a required time, stopping the heating to cool the container to a predetermined temperature, thereby producing a vacuum therein, applying oven heating to the container for a required time while the container is kept at or below a predetermined temperature.

Yet, a vacuum-sealed container for cooking food under vacuum by the methods described as the first through the fourth aspects of the present invention has a container main body and a lid which are heat-and-cold resistant and have microwave permeability, wherein the lid is provided with a check valve made of a heat-and-cold resistant rubber or rubbery elastomer formed in an umbrella shape on the upper surface of the lid, such that gases in the container flow out only unidirectionally through a vent hole, and a packing case disposed contiguously with the circumferential edge of the lid. A packing made of a heat-and-cold resistant rubber or rubbery elastomer is disposed in the packing case. A shaft of the check valve is inserted from outside into an opening provided on the lid, and the check valve is retained while a stopper ring provides the valve with a downward slight pull, such that the circumferential edge of the check valve is uniformly in intimate contact with the surface of the lid, and the check valve covers the vent hole to close. The lid and the container main body are configured to airtightly contact with each other over their entire circumferences via the packing, and to be engaged with each other by a stopper to seal the container.

As in the first aspect of the present invention stated above, food and a cooking liquid in the above-described vacuum-sealed container are heated using a microwave oven at high power to raise the temperature sharply for boiling. Accordingly, the food is heated from inside, and contaminating bacteria and parasites are killed within a short time. In addition, when water evaporates, its volume increases more than a thousand times under atmospheric pressure. By taking advantage of this, steam produced from the food and the cooking liquid releases and deaerates almost all air from the container. If the container is cooled down, the temperature in the container decreases, and the steam condenses. The remaining air in the container becomes extremely tenuous, and the container is automatically sealed, thereby producing a vacuum therein. Then, when the container is kept warm and heated at low temperatures for long hours using a microwave oven at low power, vacuum cooking becomes possible.

Since food is heated at low temperatures for many hours, even meat can become tender and tastier than conventionally cooked meat. During low-temperature cooking, tasty juices come out from the food itself. When the food is heated under vacuum, thereby boiling and stirring a cooking liquid, it can be expected that the cooking liquid and the tasty juices may permeate the food uniformly without being released to the outside. If the container is allowed to cool after heating for a required time, the steam in the container condenses, whereby the volume of the air decreases, and its density becomes extremely tenuous. Consequently, oxidation and deterioration of the food can be prevented.

In addition, as in the second aspect of the present invention, food and a cooking liquid in the above vacuum-sealed container are heated using a microwave oven at high power to raise a temperature sharply for boiling. After heating the food and the cooking liquid for a required time, the heating is stopped to cool the container, thereby producing a vacuum therein. The food and the cooking liquid are heated at a predetermined low temperature while the container is under vacuum, whereby the cooking liquid keeps boiling and is stirred. Then, heating is stopped to allow the container to cool. Besides, the container is stored in a refrigerator. Consequently, the cooking liquid can permeate the food, and the tasty juices from the food can be condensed.

Further, as in the third aspect of the present invention, food and a cooking liquid in the above vacuum-sealed container are heated using a microwave oven at high power to raise a temperature sharply for boiling. After heating the food and the cooking liquid for a required time, the heating is stopped to cool the container to a predetermined temperature, thereby producing a vacuum therein. Then, the vacuum-sealed container is placed in a regular keep-warm box, as it is, for keep-warm cooking for a required time. The cooking liquid in the vacuum-sealed container keeps boiling at low temperatures and is stirred, whereby permeation of the cooking liquid into the food and condensation of the tasty juices from the food can be accelerated.

Moreover, as in the fourth aspect of the present invention, food and a cooking liquid in the above vacuum-sealed container are heated using a microwave oven at high power to raise its temperature sharply for boiling. After heating the food and the cooking liquid for a required time, the heating is stopped to cool the container to. a predetermined temperature, thereby producing a vacuum therein. Then, when the food and the cooking liquid are cooked by oven heating for a required time using a conventional oven or a microwave oven capable of serving as a conventional oven to keep them at or lower than a predetermined temperature, the cooking liquid in the vacuum-sealed container keeps boiling at low temperatures and is stirred. Consequently, the cooking liquid can permeate the food, and the tasty juices from the food can be condensed.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

### BRIEF DESCRIPTION OF THE DRAWINGS

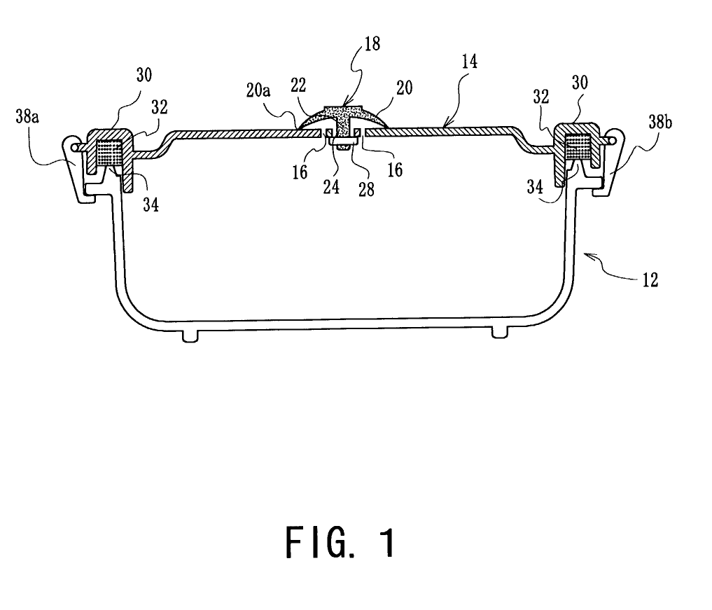

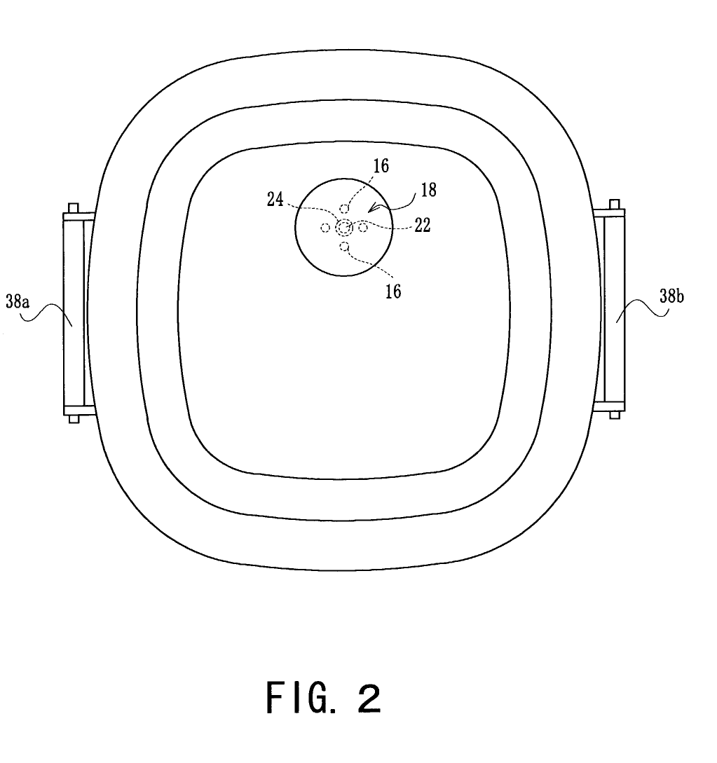

The accompanying drawings, which are incorporated in and constitute a part of this specification, illustrate embodiments of the present invention and, together with the description, serve to explain the objects, advantages and principles of the invention. In the drawings, FIG. 1 is a sectional view of a vacuum-sealed container according to the present invention, and FIG. 2 is a plane view of the same.

### DETAILED DESCRIPTION OF THE PREFERRED EMBODIMENTS

A detailed description of one preferred embodiment of a vacuum cooking method using a microwave oven and a vacuum-sealed container used for the method (hereinafter referred to as a “vacuum container”) embodying the present invention will now be given referring to the accompanying drawings. FIG. 1 is a sectional view showing a general structure of a vacuum container 10 applied to the vacuum cooking method according to the present invention. FIG. 2 is a plane view of the same.

The illustrated vacuum container 10 constitutes a container main body 12 and a lid 14 to be attached thereto. The container main body 12 is made of a synthetic resin such as a polyether resin or a polysulfonic resin having heat resistance, cold resistance, and microwave permeability. The lid 14 has a check valve 18 on its upper surface and a packing case 30 disposed contiguously to its circumferential edge. The check valve 18 is shaped like an umbrella, and is made of a heat-and-cold resistant rubber or rubbery elastomer. The check valve 18 is designed to induce a unidirectional outflow of gases from the inside of the container 10 only to the outside through vent holes 16s, thus preventing an inflow of external air into the container 10. Mounted inside the packing case 30 is a packing 32, which is also made of a heat-and-cold resistant rubber or rubbery elastomer. A shaft 22 of the check valve 18 is inserted into an opening 24 from the front side of the lid 14, and is retained by a stopper ring 28 which provides a downward slight pull so that a circumferential edge 20a of an umbrella-shaped valve element 20 may be in intimate and uniform contact with the surface of the lid 14, and so that the check valve 18 may cover and close all of the vent holes 16s. The lid 14 and an upper circumferential edge 34 of the container main body 12 are in airtight contact with each other through the packing 32, and are engaged with each other by removable stoppers 38a and 38b to seal the container 10 hermetically.

In a first embodiment of the present invention, food and a cooking liquid are put into the container main body 12 of the container 10. The container main body 12 is covered and engaged with the lid 14 using the stoppers 38a and 38b to seal the container 10 hermetically. Then, the container 10 is heated in a microwave oven at high power to raise the temperature inside the container to 90 to 100° C. for boiling. This generates steam and expands air inside the container, thereby raising the inside pressure. Consequently, the inside air is discharged through space between the lid 14 and the container main body 12 and through the vent holes 16s under the check valve 18, causing deaeration during which the food is sterilized. After the heating is stopped and the container 10 is cooled down, the container 10 is automatically sealed, thus producing a vacuum therein. When the temperature in the vacuum container 10 falls to 60° C., the container 10 is placed in the microwave oven, and continues to be heated at low power constantly at 55 to 65° C., which permits the food to be cooked under vacuum. After heated for a required time, the vacuum container 10 is allowed to cool. As a result, the cooking liquid permeates the food, thereby achieving the object of the present invention.

In a second embodiment of the present invention, food and a cooking liquid are put into the container main body 12 of the container 10. The container main body 12 is covered and engaged with the lid 14 using the stoppers 38a and 38b to seal the container 10 hermetically. Then, the container 10 is heated in a microwave oven at high power to raise the temperature inside the container to 90 to 100° C. for boiling. This generates steam and expands air inside the container, thereby raising the inside pressure. Consequently, the inside air is discharged through space between the lid 14 and the container main body 12 and through the vent holes 16s under the check valve 18, causing deaeration during which the food is sterilized. After the heating is stopped and the container 10 is cooled down, the container 10 is automatically sealed, thus producing a vacuum therein. When the temperature in the vacuum container 10 falls to 60° C., the container 10 is placed in the microwave oven, and continues to be heated at low power constantly at 55 to 65° C., which permits the food to be cooked under vacuum. After heated for a required time, the vacuum container 10 is allowed to cool and stored in a refrigerator. Then, a higher vacuum is attained inside the container 10, so that the cooking liquid permeates the food and that a good taste condenses, thereby achieving the object of the present invention.

In a third embodiment of the present invention, food and a cooking liquid are put into the container main body 12 of the container 10. The container main body 12 is covered and engaged with the lid 14 using the stoppers 38a and 38b to seal the container 10 hermetically. Then, the container 10 is heated in a microwave oven at high power to raise the temperature inside the container to 90 to 100° C. for boiling. This generates steam and expands air inside the container, thereby raising the inside pressure. Consequently, the inside air is discharged through space between the lid 14 and the container main body 12 and through the vent holes 16s under the check valve 18, causing deaeration during which the food is sterilized. After the heating is stopped and the container 10 is cooled down, the container 10 is automatically sealed, thus producing a vacuum therein. When the temperature in the vacuum container 10 falls to 70° C., the container 10 is placed in a conventional keep-warm box to be kept warm. In the vacuum container 10, the cooking liquid continues boiling to be stirred. Thus, the food is cooked while being kept warm under vacuum. As a result, the cooking liquid and tasty juices from ingredients permeate the food uniformly, thereby achieving the object of the present invention.

In a fourth embodiment of the present invention, food and a cooking liquid are put into the container main body 12 of the container 10. The container main body 12 is covered and engaged with the lid 14 using the stoppers 38a and 38b to seal the container 10 hermetically. Then, the container 10 is heated in a microwave oven at high power to raise the temperature inside the container to 90 to 100° C. for boiling. This generates steam and expands air inside the container, thereby raising the inside pressure. Consequently, the inside air is discharged through space between the lid 14 and the container main body 12 and through the vent holes 16s under the check valve 18, causing deaeration during which the food is sterilized. After the heating is stopped and the container 10 is cooled down, the container 10 is automatically sealed, thus producing a vacuum therein. When the temperature in the vacuum container 10 falls to 70° C., the container 10 is subjected to oven heating in an oven or a microwave oven capable of serving as a conventional oven to keep the temperature inside the container 10 at 70° C. or lower. In the vacuum container 10, the cooking liquid continues boiling to be stirred, so that the cooking liquid permeates the food and that a good taste condenses, thereby achieving the object of the present invention.

### EXAMPLE 1

Pork cut into cubes to be braised and a cooking liquid were put into a container designed according to the present invention. The container was covered with a lid to be sealed hermetically with stoppers. Then it was heated in a microwave oven at 1000-watt power for five minutes to raise the temperature inside the container to 90 to 100° C. After boiling, heating was continued for 15 minutes and stopped. The container was allowed to cool until 70° C. to produce a vacuum therein. Then, the vacuum-sealed container was heated further at 200-watt or equivalent power at 70 to 80° C. for 25 minutes. Meanwhile, the inside of the container was maintained under vacuum, and the cooking liquid continued boiling to be stirred. The cooking liquid thereby permeates the pork more quickly and deeply. Even after the heating was stopped and the vacuum-sealed container was allowed to cool, the cooking liquid continued boiling for two hours.

Then, the vacuum sealing was released, and the braised pork was tried for a taste. It was turned out that the pork had become tender and that the cooking liquid had permeated sufficiently, thereby obtaining a delicious taste.

### EXAMPLE 2

In the above Example 1, the vacuum sealing was not released, and the vacuum-sealed container was stored in a refrigerator at 5° C. until the next day when the container was opened. The braised pork was tried for a taste, and turned out to have become more delicious, because the permeation of the cooking liquid had been deepened further, and because tasty juices from the pork had been reabsorbed into the pork and had condensed.

### EXAMPLE 3

Root vegetables such as potatoes and/or carrots to be simmered were cut into pieces, and were put into the container according to the present invention. The container was covered with the lid to be sealed hermetically with the stoppers. Then it was heated in the microwave oven at 1000-watt power for three minutes to raise the temperature inside the container to 90 to 100° C. After boiling, heating was continued for 10 minutes and stopped. The container was allowed to cool until 70° C. to produce a vacuum therein. Then, the vacuum-sealed container was heated further at 200-watt or equivalent power at 70 to 80° C. for 25 minutes. Meanwhile, the inside of the container was maintained under vacuum, and the cooking liquid started boiling to be stirred. The cooking liquid thereby permeates the vegetables more quickly and deeply. Even after the heating was stopped and the vacuum-sealed container was allowed to cool, the cooking liquid continued boiling for one hour.

Then, the vacuum sealing was released, and the simmered vegetables were tried for a taste. It was turned out that the vegetables had become soft and that the cooking liquid had soaked into them sufficiently, thus obtaining a delicious taste. In addition, the vegetables had maintained high nutritional values because the nutrients in them had not been decomposed.

### EXAMPLE 4

The same pork and cooking liquid as in Example 1 were put into the container designed according to the present invention. The container was covered with the lid, and was tightly sealed with the stoppers. Then it was heated in a microwave oven at 1000-watt power for five minutes to raise the temperature inside the container to 90 to 100° C. for boiling. After the heating was continued for 15 minutes and stopped, the container was allowed to cool to 70° C. to produce a vacuum therein, and the cooking liquid boiled to be stirred. The vacuum-sealed container was then placed in a conventional keep-warm box to cook the pork by keeping it warm. During the keep-warm cooking, the cooking liquid continued boiling to be stirred in the vacuum-sealed container.

Then, the container was taken out to release the vacuum, and the braised pork was tried for a taste. It was turned out that the pork had become tender enough and that the cooking liquid and the juices from the pork had permeated sufficiently, thus obtaining a delicious taste.

### EXAMPLE 5

The same pork and cooking liquid as in Example 1 were put into the container designed according to the present invention. The container was covered with the lid, and was tightly sealed with the stoppers. Then it was heated in a microwave oven at 1000-watt power for five minutes to raise the temperature inside the container to 90 to 100° C. for boiling. After the heating was continued for 15 minutes and stopped, the container was allowed to cool to 60° C. to produce a vacuum therein, and the cooking liquid boiled to be stirred softly. Then, the vacuum-sealed container was heated at a constant temperature of 65° C. for 30 minutes in an oven or a microwave oven capable of serving as a conventional oven. In the vacuum-sealed container, the cooking liquid was boiling to be stirred, so that the pork was cooked. Then, the vacuum-sealed container was taken out to release the vacuum, and the braised pork was tried for a taste, turning out to have become as delicious as in other examples.

As described above in Examples 1 to 5, the cooking method according to the present invention is excellent since it permits braised pork to be more delicious than ordinary cooking methods, although it is said that braised pork is difficult to fix among other meat dishes. Curry or stew using beef or chicken, for example, or other simmered/braised dishes using root vegetables or the like to be permeated by a cooking liquid sufficiently, may be cooked deliciously if the vacuum-cooking method according to the present invention is applied to those dishes. In addition, if the cooked food is stored in a refrigerator with its container vacuum-sealed, the food may absorb the cooking liquid and tasty juices from the ingredients sufficiently, and a good taste may condense.

To add to this, in Examples 2 and 4, the pork was braised deliciously without becoming tough, due to a relatively short time for subjecting the pork to microwave heating of which drawback is rendering meat tougher.

The foregoing description of the preferred embodiments of the invention has been presented for purposes of illustration and description. It is not intended to be exhaustive or to limit the invention to the precise form disclosed, and modifications and variations are possible in the light of the above teachings or may be acquired from practice of the invention. The embodiments chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A vacuum cooking method for cooking food using a microwave oven, so that permeation of a cooking liquid into the food is accelerated, comprising the steps of:
heating the food and the cooking liquid in a heat-and-cold resistant vacuum-sealed container having microwave permeability using the microwave oven at high power for boiling;
heating the container for a required time;
stopping the heating to cool the container, thereby producing a vacuum therein;
heating the container for a required time to cook the food and the cooking liquid at low temperatures using the microwave oven at low power, while the container is under vacuum; and
allowing the container to cool.

2. A vacuum cooking method for cooking food using a microwave oven, so that a cooking liquid permeates into the food, and a good taste is condensed, comprising the steps of:
heating the food and the cooking liquid in a heat-and-cold resistant vacuum-sealed container having microwave permeability using the microwave oven at high power for boiling;
heating the container for a required time;
stopping the heating to cool the container, thereby producing a vacuum therein;
heating the container for a required time to cook the food and the cooking liquid at low temperatures using the microwave oven at low power, while the container is under vacuum;
allowing the container to cool; and
storing the container in a refrigerator.

3. A vacuum cooking method for cooking food using a microwave oven, so that a cooking liquid permeates the food, and a good taste is condensed, comprising the steps of:
heating the food and the cooking liquid in a heat-and-cold resistant vacuum-sealed container having microwave permeability using the microwave oven at high power for boiling;
heating the container for a required time;
stopping the heating to cool the container to a predetermined temperature, thereby producing a vacuum therein; and
placing the container in a keep-warmbox for keep-warm cooking for a required time while the container is under vacuum.

4. A vacuum cooking method for cooking food by microwave-oven heating and oven heating, so that a cooking liquid permeates the food, and a good taste is condensed, comprising the steps of:
heating the food and the cooking liquid in a heat-and-cold resistant vacuum-sealed container having microwave permeability using a microwave oven at high power for boiling;
heating the container for a required time;
stopping the heating to cool the container to a required temperature, thereby producing a vacuum therein;
applying oven heating to the container for a required time while the container is kept at or below a predetermined temperature.

5. A vacuum-sealed container for cooking food under vacuum as in any of the preceding claims, having a container main body and a lid which are heat-and-cold resistant and have microwave permeability, wherein:
the lid comprises a check valve made of a heat-and-cold resistant rubber or rubbery elastomer formed in an umbrella shape on an upper surface of the lid, such that gases in the container flow out only unidirectionally through a vent hole, and a packing case disposed contiguously with the circumferential edge of the lid;
a packing made of a heat-and-cold resistant rubber or rubbery elastomer is disposed in the packing case;
a shaft of the check valve is inserted from outside into an opening provided on the lid, and the check valve is retained while a stopper ring provides the valve with a downward slight pull, such that the circumferential edge of the check valve is uniformly in intimate contact with the surface of the lid, and the check valve covers the vent hole to close;
the lid and the container main body are configured to airtightly contact with each other over their entire circumferences via the packing, and to be engaged with each other by a stopper to seal the container.
